(19) United States
(12) Patent Application Publication
(10) Pub. No.: US 2015/0310240 A1
(43) Pub. Date: Oct. 29, 2015

(54) SYSTEM AND METHOD FOR REAL TIME TRACKING USING COMBINED NEAR FIELD AND FAR FIELD RADIO FREQUENCY IDENTIFICATION

(71) Applicant: THE RESEARCH FOUNDATION FOR THE STATE UNIVERSITY OF NEW YORK, Albany, NY (US)

(72) Inventors: Satya SHARMA, Setauket, NY (US); Akshay ATHALYE, Port Jefferson Station, NY (US)

(21) Appl. No.: 14/647,591

(22) PCT Filed: Nov. 27, 2013
(86) PCT No.: PCT/US2013/072308

§ 371 Date: May 27, 2015

Related U.S. Application Data
(60) Provisional application No. 61/730,215, filed on Nov. 27, 2012.
(60) Provisional application No. 61/886,407, filed on Oct. 3, 2013.

(51) Int. Cl. G06K 7/10; H04W 4/02

(52) U.S. Cl. CPC G06K 7/10415; H04W 4/02

(57) ABSTRACT

Provided is a portable transport apparatus having an enclosure for containing an item to be transported, a RFID reader connected to a near field antenna disposed within the enclosure for a first RFID reading of an area inside the enclosure and to a far field antenna disposed on the enclosure for a second RFID reading of an area outside the enclosure, and a wireless communication module, and a method of use of the portable transport apparatus.

### PRIORITY

This application claims priority to U.S. Provisional Patent Applications Nos. 61/730,215 and 61/886,407, which were filed with the U.S. Patent and Trademark Office on Nov. 27, 2012, and Oct. 3, 2013, respectively, the contents of which are incorporated herein by reference.

### BACKGROUND OF THE INVENTION

1. Field of the Invention

The present invention generally relates to methods and systems for specimen tracking and, in particular, to a method and system that provides a unitary system for real time tracking of a container, as well as contents of the container, during transport within and external to a building, to provide real-time verification of container content.

2. Description of the Related Art

Millions of specimens and medications are transported within hospitals, as well as between hospitals and testing labs, on a daily basis. Conventionally, specimens/medications are labeled for transport, with barcodes or handwritten labels manually applied either directly onto the specimen/medication or to a specimen/medication holder. A sender places the label on an item, the item is transported, and a receiver acknowledges receipt of the item. This process is resource intensive and prone to human error. In addition, such conventional systems fail to allow for tracking during transport, particularly when one or more specimens/medications are packed within a container.

In conventional systems, the item or container can be misdirected, and specimens/medications can be erroneously loaded before being placed within the container. Once the specimen/medication is loaded into the container, real-time updates confirming a position of the container, as well as the contents of the container, are unavailable.

In addition, conventional systems do not allow for automated reconciliation and tracking of medication/specimens during delivery. Rather, once the medication/specimen is dispatched for delivery, the sender and recipient are unable to positively identify the location of the medication/specimen until the container arrives, which can lead to unnecessary re-ordering of overdue medication.

The inability of conventional systems to provide real time tracking of container content raises a particular concern in a hospital environment, i.e., to avoid delayed administration of medication. In regards to specimen transport, which often begins in an operating room where the specimen is obtained and placed within the transport container, often with a preservative medium, e.g., ice, water, or formalin, degradation of the preservative medium and associated specimen spoliation presents issues that can be addressed by providing a method and system for real time tracking of container content during transport.

Issues with the inability of conventional systems to validate transport of specimens/medications extend beyond the hospital facility, since medications may be dispatched from a pharmacy to patient rooms, and may also be are often obtained from a supplier that is external to, i.e., located outside of, the hospital. Obtaining proper medication from external suppliers in a timely manner involves a complex series of inter-related processes. Accordingly, hospitals use various software programs to allow hospital personnel to order particular medications, and to specify the delivery destination as the operating room, patient room, or other hospital area. However, conventional systems fail to provide an integrated system that can track medication/specimen delivery both within and outside of the hospital, i.e., to a pharmacy and beyond.

In an effort to address this and other shortcomings of conventional systems, a Radio Frequency IDentification (RFID) tracking system has been proposed. See, e.g., U.S. Pat. No. 8,116,906 to Valerino. However, this conventional system merely tracks an RFID tag affixed to an exterior of a container as the container travels through a pneumatic tube transport system, but fails to provide a way to recognize, during transit, the items that are contained within the container. In addition, this conventional system relies on a plurality of receiving stations that read an RFID tag placed on the exterior of the container, with each of the plurality of receiving stations being active readers, which have a shortcoming of reading only the container tag, and requiring separate power sources.

Therefore, provided herein is a method that accurately tracks medications/specimens and provides an integrated system for tracking medications/specimens both within a hospital and between the hospital and external facilities, i.e., both indoors and outdoors, and that overcomes disadvantages of conventional detectors.

### SUMMARY OF THE INVENTION

Accordingly, aspects of the present invention address the above problems and disadvantages, and provide the advantages described below. An aspect of the present invention provides a portable transport apparatus with an enclosure within which an item to be transported is contained. The portable transport apparatus includes an embedded Radio Frequency Identification (RFID) reader connected to a Near-Field (NF) antenna system disposed within the enclosure to perform a first RFID reading of an area inside the enclosure, a Far-Field (FF) antenna system disposed on the enclosure to obtain a second RFID reading of an area outside the enclosure, and an embedded controller for controlling the operation of the RFID reader and communicating the collected information wirelessly to a remote server.

Another aspect of the present invention provides a method for real time tracking of a portable transport apparatus, in which a specimen is collected at a surgical location, a RFID tag associated with the specimen is programmed, the specimen is placed in a specimen holder, the programmed RFID tag is affixed on the specimen holder containing the specimen, the specimen holder is loaded into a portable transport apparatus, and the portable transport apparatus interrogates the programmed RFID tag. The portable transport apparatus interrogates a first RFID tag, communicates first data obtained from the first RFID tag with a database, interrogates a second RFID tag, and communicates second data obtained from the second RFID tag to the database.

### BRIEF DESCRIPTION OF THE DRAWINGS

The above and other aspects, features and advantages of certain embodiments of the present invention will be more apparent from the following detailed description taken in conjunction with the accompanying drawings, in which:

FIG. 1(a) is a perspective view of a portable transport apparatus of the present invention;

FIG. 1(b) is a plan view of the portable transport apparatus of FIG. 1(a);

FIG. 1(c) is another plan view of the portable transport apparatus of FIG. 1(a);

FIG. 2 is a side profile cut-away view of another embodiment of the portable transport apparatus and a database of the present invention;

FIG. 3 illustrates a system for real-time tracking of items placed within an enclosure of the portable transport apparatus of the present invention; and

FIGS. 4a-4b provide a flowchart of a method of the present invention.

### DETAILED DESCRIPTION OF EMBODIMENTS OF THE INVENTION

The following detailed description of certain embodiments of the present invention will be made with reference to the accompanying drawings. In describing the invention, explanation about related functions or constructions known in the art are omitted for the sake of clearness in understanding the concept of the invention, to avoid obscuring the invention with unnecessary detail.

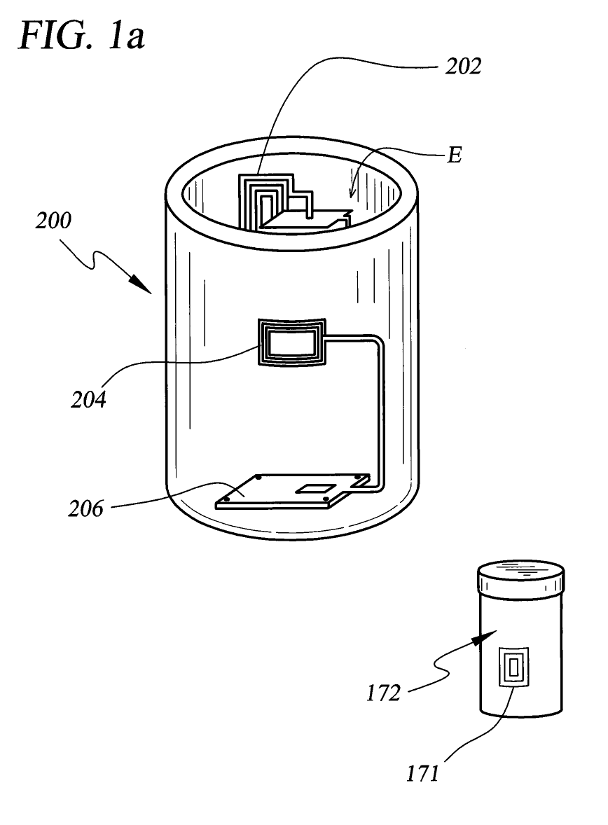

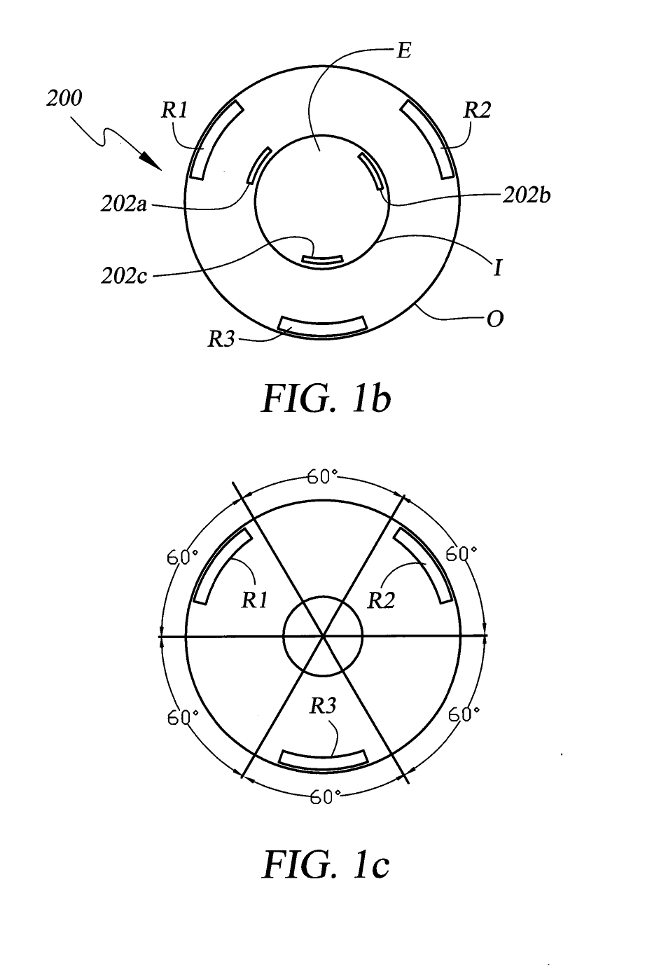

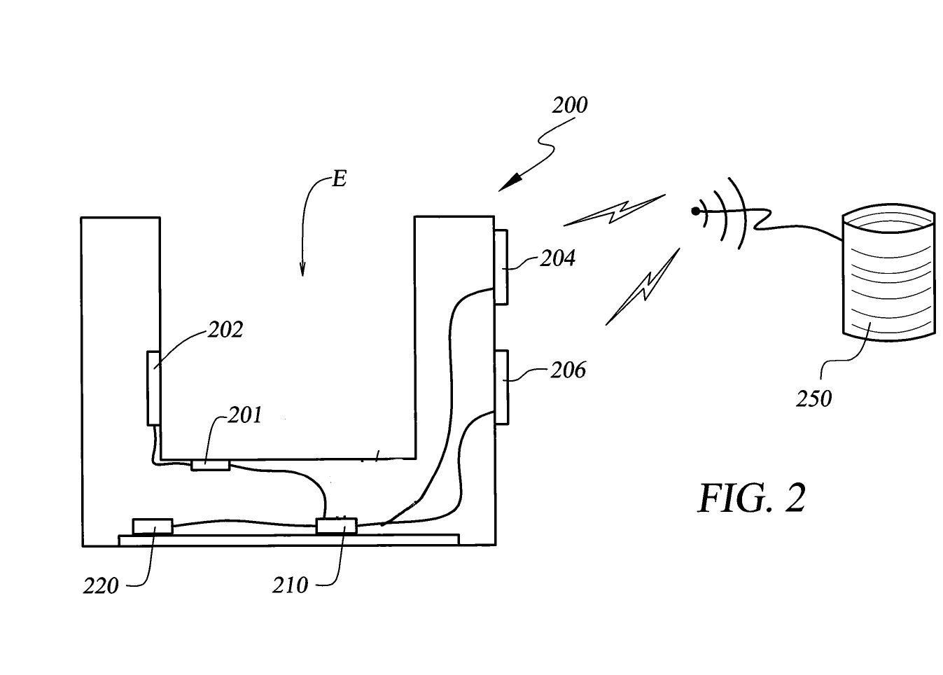

FIGS. 1(a)-(c) and 2 illustrate components of the portable transport apparatus, also referred to herein as a container, usable to transport medication, patient specimens, and other items that fit within the container.

FIG. 1(a) is a perspective view of a portable transport apparatus of the present invention. As shown in FIG. 1(a), the portable transport apparatus, i.e., container 200, includes an enclosure (E) within which item(s) to be transported, i.e., the medication, patient specimen, etc., are positioned. Container 200 includes a near field RFID antenna 202, a far field antenna 204, which can be formed, e.g., as a Yagi-type or similar antenna, and a wireless communication module 206. Wireless communication module 206 communicates by IEEE 802.11b or WIFI communication protocol when indoors, and by Global System for Mobile (GSM) communication and other telecommunication protocol when outdoors.

FIG. 1(b) provides a plan view of an embodiment of portable transport apparatus 200 of FIG. 1(a), showing near field RFID antenna 202 implemented as separate antennas (202a, 202b, 202c) spaced at uniform intervals around an interior of container 200, to provide improved accuracy of reading of each of the first RFID tags 171 within enclosure (E).

As shown in FIG. 1(b), reflectors (R1, R2, R3) are provided at exterior positions of the container to shield corresponding antennas (202a, 202b, 202c). FIG. 1(c), which provides another plan view of portable transport apparatus 200, illustrates positioning of reflectors (R1, R2, R3) and corresponding antennas (202a, 202b, 202c) at sixty degree intervals.

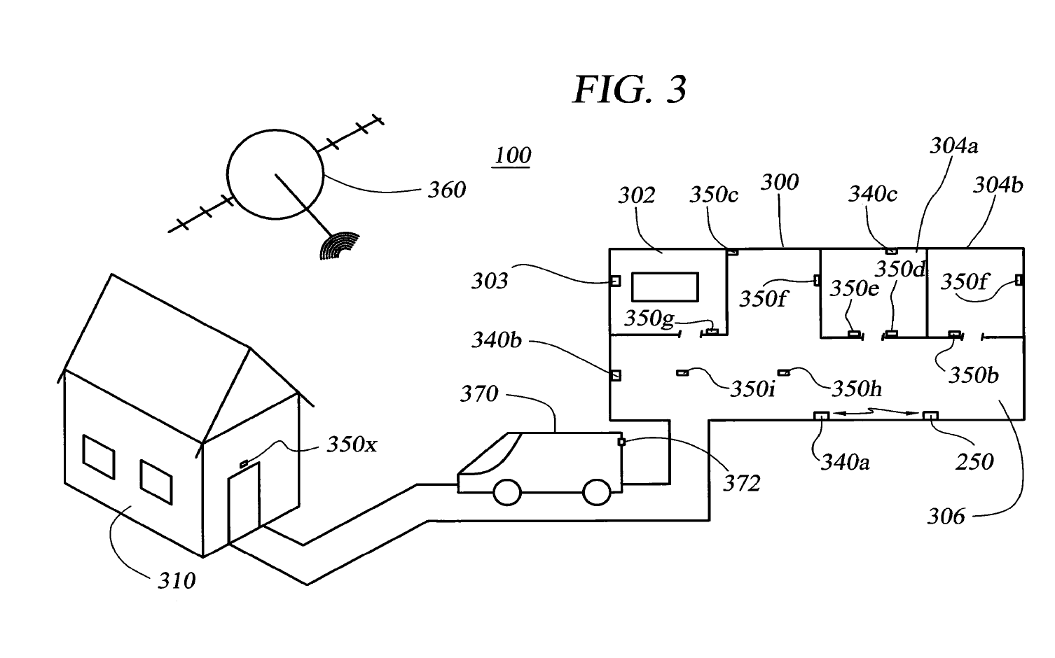

FIG. 2 is a side profile cut-away view of portable transport apparatus 200 and database system 250 of an embodiment of the present invention. As shown in FIG. 2, near field RFID antenna 202 functions with RFID reader 201. Near field RFID antenna 202 is disposed within enclosure (E) to perform first RFID readings of one or more first RFID tag(s) 171 affixed on a medication/specimen holder(s) 172 that are positioned within enclosure (E) of container 200.

Also shown in FIG. 1 is far field antenna 204 that can be separately provided to perform a second RFID reading of external RFID tags, i.e., RFID tags located in an area outside the enclosure. The first and second RFID readings can alternatively be obtained by a single antenna. FIG. 2 also shows wireless communication module 206, controller 210, bottom reflector R_{B} and rechargeable battery 220. Upon detection of sealing of container 200, controller 210 instructs RFID reader 201 to perform a first RFID reading of each RFID tag located within enclosure (E). Based on the first RFID reading, controller 210 creates a list of the first RFID tags and communicates the RFID scanning result and list of first RFID tags to database system 250 via wireless network connection 240.

Controller 210 controls RFID reader 201 to interrogate one or more first RFID tags 171 using the NF antenna 202, and to interrogate a plurality of second RFID tags 350a . . . x that are external to container 200 using the FF antenna 204. Utilizing power from battery 220 of container 200 to power RFID reader 201 allows for use of passive RFID tags on the specimen/medication holder 172 as well as at various points along which the container 200 may travel.

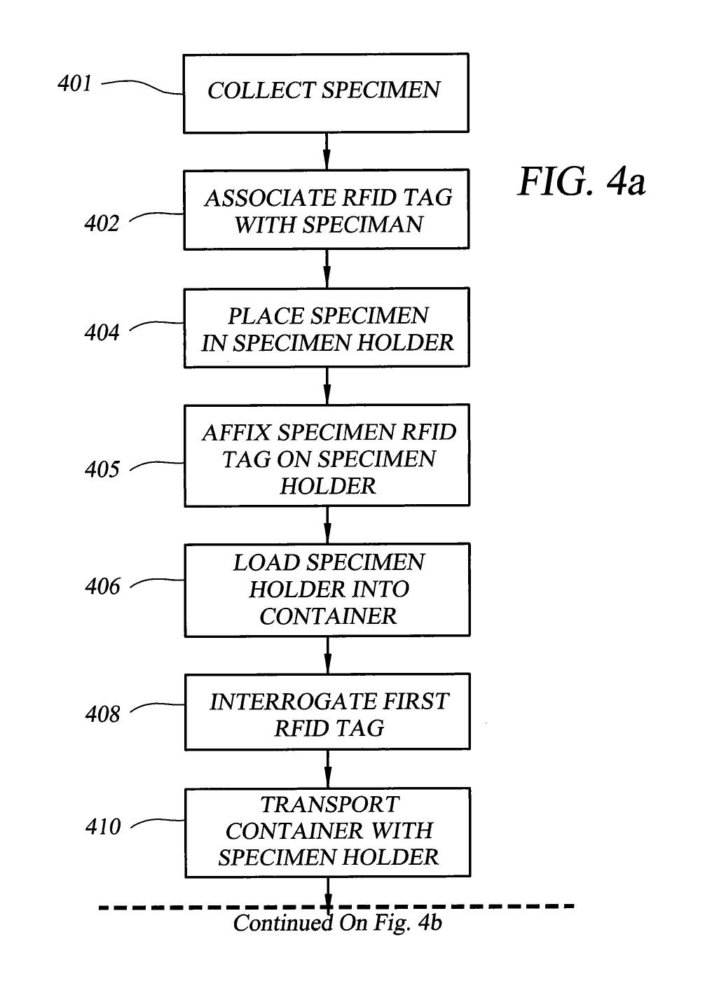

A current, real-time position of container 200 is provided by controller 210 communicating with database system 250 via IEEE 802.11b, WIFI, or GSM communication, depending on container 200 location. FIG. 3 shows a system 100 that provides real-time tracking of items that are placed within an enclosure of container 200, which is portable, as well as the position of container 200 itself.

As shown in FIG. 3, system 100 is provided in a medical facility/hospital 300 and a lab 310 that is external to hospital 300. Hospital 300 includes an operating room 302, which includes an RFID tag programmer 303 configured to associate an RFID tag 171 with a tissue specimen or other sample obtained by hospital personnel in operating room 302. Associating RFID tag 171 with the specimen/sample includes identifying a patient from which the specimen/sample was obtained, identifying one or more tests to be performed on the specimen/sample, and printing a unique RFID tag 171 with an adhesive back for affixing the RFID tag 171 to specimen/medication holder 172.

As shown in FIG. 3, a plurality of second RFID tags 350a . . . i are affixed at predefined positions throughout hospital 100, i.e., in operating room 302, in a plurality of rooms 304a, 304b, as well as in hallway 306. The second RFID tags are preferably passive, allowing for simple installation of additional second RFID tags to accommodate the dynamic electromagnetic characteristics of the hospital environment. The additional second RFID tags can be added without conducting a site survey, as required in conventional systems. Rather, positions of the additional second RFID tags need only be input into database system 250.

Movement of container 200 through hospital 300 and/or between hospital 300 and lab 310 results in RFID reader 201 obtaining second RFID readings from the second RFID tags 350a . . . x that are passed by container 200.

As container 200 moves, first data obtained from first RFID tag 171 is transmitted to database system 250. The first data identifies the item 170 that is loaded in enclosure E of container 200 for transport. In addition to the first data, container 200 transmits second data that identifies the second RFID tags 350a . . . x that container 200 has most recently passed. The second data identifies the position of container 200, based on the which of the plurality of second RFID tags 350a . . . x that the container has most recently passed.

When container 200 is located within hospital 300, the first and second data are communicated via wireless communication module 206 to one of WIFI access points 340a-c. When container 200 is not within range of a WIFI access point, such as when container 200 is on an external transit provider, i.e., a truck, ambulance, train, plane, messenger service, etc., for transit from hospital 300 to lab 310, wireless communication module 206 is utilized to communicate the first and second data via GSM or other telecommunication protocol. The current position can also by obtained by a GPS portion of wireless communication module 206, particularly when container 200 is outdoors.

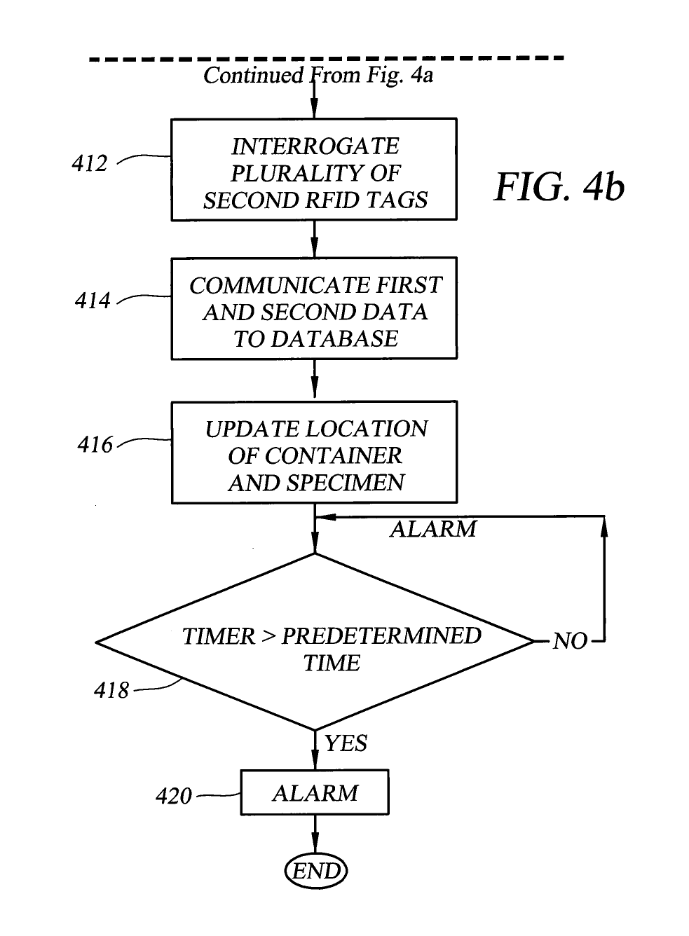

FIGS. 4a-4b provide a flowchart of a method of the invention. In Step 401, a specimen is collected, for example in operating room 302, where a surgeon obtains patient specimen. In Step 402, a first RFID tag is associated with the specimen. The first RFID tag preferably includes a patient identifier, a specimen identifier and tracking information, which preferably includes an origin identifier, a destination identifier, an identifier of a preferred route, a delivery deadline, and recommended testing. The RFID tag can be associated with the specimen by RFID tag programmer 303 located in the operating room, with the RFID tag preferably being a passive RFID tag.

In Step 404, the specimen is placed in the specimen holder 172, preferably with a preservative medium such as ice. In Step 405, the first RFID tag is affixed onto specimen holder 172, and the specimen holder 172 is sealed with the specimen and preservative medium contained therein.

In Step 406, the specimen holder 172 is loaded into transport apparatus/container 200, the transport apparatus 200 is sealed, the controller 210 is activatated upon determination of container sealing, and a timer is started. In Step 408, container 200 interrogates the first RFID tag. In Step 410, container 200, with specimen holder 172, is transported either within the hospital or between the hospital and lab.

In Step 412, one or more of a plurality of second RFID tags are interrogated to obtain a current location of the container 200 and specimen holder 172.

In Step 414, the container 200 communicates the first and second data to the database system 250. In Step 416, a current location of the container 200 and of the specimen holder 172 is updated based on the received first and second data.

In Step 418, a determination is made of whether the timer exceeds a predetermined time period after loading the specimen holder into the container, and an alert is provided in Step 420 is the specimen is not collected within the predetermined time period.

While the invention has been shown and described with reference to certain aspects thereof, it will be understood by those skilled in the art that various changes in form and details may be made therein without departing from the spirit and scope of the present invention as defined by the appended claims and equivalents thereof.

What is claimed is:

1. A method comprising:
collecting a specimen;
associating a first Radio Frequency Identification (RFID) tag with the specimen;
placing the specimen in a specimen holder;
affixing the first RFID tag to the specimen holder;
loading the specimen holder into a container;
interrogating, by a controller of the container, the first RFID tag;
obtaining first data from the interrogation of the first RFID tag;
interrogating, by the controller, a second RFID tag external to the container;
obtaining second data from the interrogation of the second RFID tag;
communicating, by the controller, the first data and the second data to a database; and
identifying, by the database from the first data and the second data, a current location of the specimen holder and the container.

2. The method of claim 1, wherein the first RFID tag and the second RFID tag are passive RFID tags.

3. The method of claim 1, wherein the container communicates with the database via one of GSM and WIFI communication.

4. The method of claim 1, wherein the container includes an RFID reader configured to perform a first RFID reading of an area within the container and to perform a second RFID reading of an area outside the enclosure.

5. The method of claim 1, further comprising providing an alert when the specimen holder is not removed from the container within a predetermined time period after loading the specimen holder into the container.

6. The method of claim 1, further comprising starting a timer upon interrogating the first RFID tag.

7. The method of claim 6, further comprising providing an alert if a predetermined time period elapses before completion of interrogation of the second RFID tag.

8. The method of claim 1, wherein the specimen holder is a specimen bottle.

9. The method of claim 1, wherein the second data is obtained from a plurality of second RFID tags.

10. A portable transport apparatus comprising:
an enclosure for containing an item to be transported; and
a Radio Frequency Identification (RFID) reader configured to obtain a first RFID reading of an area inside the enclosure and to obtain a second RFID reading of an area outside the enclosure.

11. The portable transport apparatus of claim 10, further comprising a controller that is configured to, upon detection of sealing of the portable transport apparatus, send an instruction to the RFID reader to perform the first RFID reading, to receive an RFID scanning result comprising a list of tags read by the RFID reader, and to wirelessly transmit the RFID scanning result to a database system.

12. The portable transport apparatus of claim 10, wherein the second data obtained from the second RFID reading provides a current position of the apparatus.

13. The portable transport apparatus of claim 10, further comprising a rechargeable battery.

14. A method for medication transport, the method comprising:
programming a first Radio Frequency Identification (RFID) tag associated with the medication;
affixing the first RFID tag on a medication holder; and
loading the medication holder into a container;
interrogating, by a controller of the container, the first RFID tag;
obtaining first data from the interrogation of the first RFID tag;
interrogating, by the controller, a second RFID tag external to the container;
obtaining second data from the interrogation of the second RFID tag;
communicating, by the controller to a database, the first data and the second data; and
identifying, by the database from the first data and the second data, a current location of the specimen holder and the container.
